(19) United States
(12) Patent Application Publication
(10) Pub. No.: US 2013/0173567 A1
(43) Pub. Date: Jul. 4, 2013

(54) DEFERRED RELEASE PROCESSING WITHOUT DATABASE RECORD LOCKING

(71) Applicant: Rick Onsgard, Blaine, MN (US)

(72) Inventor: Rick Onsgard, Blaine, MN (US)

(21) Appl. No.: 13/339,499

(22) Filed: Dec. 29, 2011

(51) Int. Cl. G06F 7/00; G06F 17/30

(52) U.S. Cl. 707/704; 707/E17.005

(57) ABSTRACT

Performance in databases stored over multiple host computer systems may be improved by writing and releasing records without locking the records. An attribute flag may be set on certain records in a database to indicate to the database that the records may be written and released without locking the records. When the attribute flag is set, the record may be processed during deferred processing by writing a free bit pattern and releasing the record without locking the record.

The instant disclosure relates to databases. More specifically, this disclosure relates to operating databases for access by multiple host computer systems.

### BACKGROUND

Databases are often the backbone of software applications and perform a significant amount of processing. For example, a database may serve as a back-end to a software application for storing and updating air waybills for transporting packages between countries. When functioning as a back-end for storing data, the data may be accessed by many simultaneous users. Precautions are taken in the database to prevent access by multiple users from corrupting the data. In one scenario, a user may attempt to update a record in a database with different data without being aware of other users attempting to update or access the record.

One safeguard implemented in databases is a locking mechanism, which locks records during an update process. The locked record prevents other users from updating the record until the update requested by the first user is complete. However, locking and unlocking records creates overhead processing for the database, which reduces the performance of the database.

### SUMMARY

According to one embodiment, a method includes receiving a request to release a record in a database. The method also includes identifying the record as a non-locking record. The method further includes releasing the record without locking the record.

According to another embodiment, a computer program product includes a non-transitory computer readable medium having code to receive a request to release a record in a database. The medium also includes code to identify the record as a non-locking record. The medium further includes code to release the record without locking the record.

According to a further embodiment, an apparatus includes a processor. The apparatus also includes a memory storing at least a portion of a database, in which the memory is coupled to the processor. The processor is configured to receive a request to release a record in the database. The processor is also configured to identify the record as a non-locking record. The processor is further configured to release the record without locking the record.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a database hosted on multiple systems according to one embodiment of the disclosure.

FIG. 2 is a flow chart illustrating an exemplary method of releasing a record according to one embodiment of the disclosure.

FIG. 3 is a flow chart illustrating an exemplary method of releasing a record according to another embodiment of the disclosure.

FIG. 4 is block diagram illustrating a computer network according to one embodiment of the disclosure.

FIG. 5 is a block diagram illustrating a computer system according to one embodiment of the disclosure.

### DETAILED DESCRIPTION

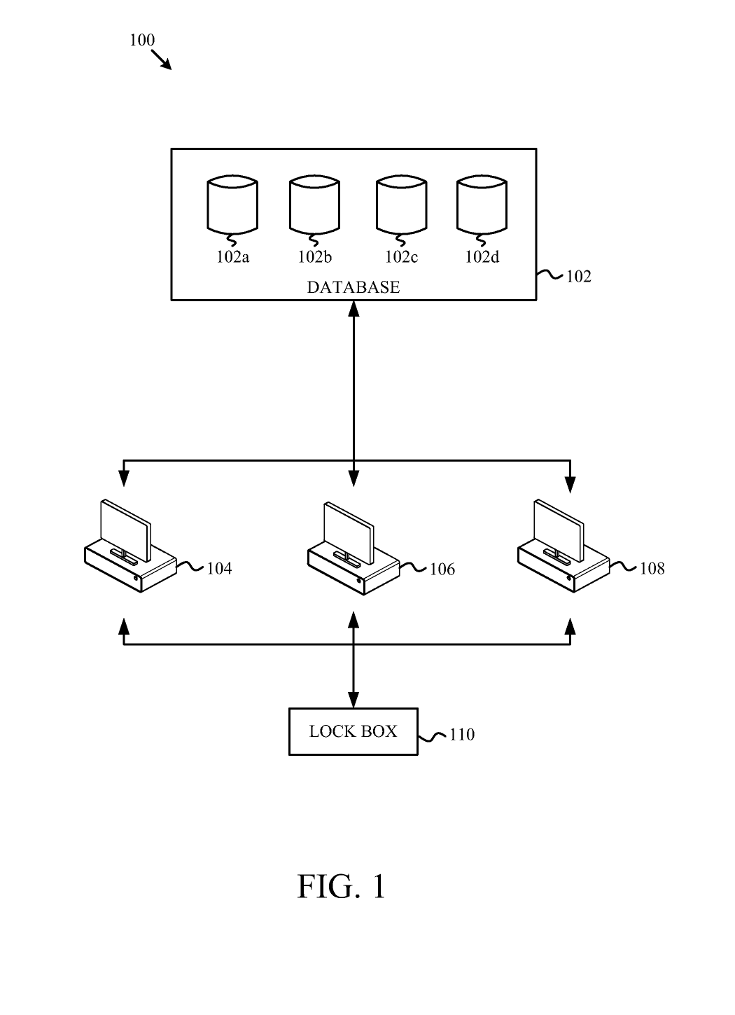

The locking and unlocking of database records to protect the database from corruption when accessed by multiple users creates overhead that may be bypassed on some database records. Although the overhead may be acceptable when the database is hosted on a single computer system, the overhead of locking and unlocking records increases when the database is hosted on multiple host computer systems. FIG. 1 is a block diagram illustrating a database hosted on multiple systems according to one embodiment of the disclosure. A system 100 includes a multi-host database 102. The database 102 may be accessed by users 104, 106, and 108. According to one embodiment, the users 104, 106, and 108 may correspond to or be located on different hosts in a multi-host environment. Locking of records in the database 102, and other databases (not shown), may be controlled by a lockbox 110.

The records of the database 102 are distributed between multiple data stores 102a-d. Input/output operations may be carried out slower over a multiple host system then in a single host system. Thus, operations involving locking of records, which add to the overhead of the database by involving the lockbox 110 in database operations, may degrade performance of the database 102. For example, writing a free bit pattern to the record during the release process may create unacceptable overhead in database accesses.

According to one embodiment, the database 102 may be operating in a deferred release processing mode. When operating in deferred release mode, a database may delay the release of certain records until a time when fewer database operations are being processed.

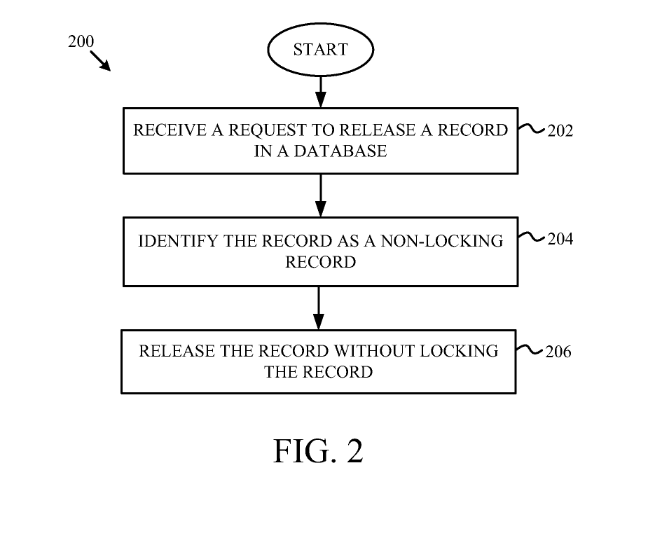

An attribute for a database record, such as a locking attribute, may be used to indicate that locking is not used for a particular database record. FIG. 2 is a flow chart illustrating an exemplary method of releasing a record according to one embodiment of the disclosure. A method 200 begins at block 202 with receiving a request to release a record in a database. At block 204, the database identifies the record as a non-locking record. The database may identify the record based on an attribute flag associated with the record. The attribute flag may specify that the particular record associated with the attribute flag should not be locked during the process of releasing the record. At block 206, the record is released without locking the record. Releasing the record without locking the record reduces access to the lockbox 110 of FIG. 1 and reduces overhead involved in releasing the record. According to one embodiment, a database operating in a deferred release mode may proceed to write the free bit pattern to the released record.

Locking of records during deferred releasing may be optional. However, if the database is being accessed as a direct access file, it may be desirable to lock the records during release processing. In one example, an integrated recovery utility (IRU) leg compare operation accesses the database as a direct access for comparing two legs of a database file and repairing or recovering database files. If deferred release processing does not lock the record during writing, the result may be IRU miscompares. In the event, an IRU miscompare occurs, an IRU compare may be executed again to verify the miscompares. However, an attribute flag may be used to allow a database administrator an option to select whether a record is locked during deferred release processing.

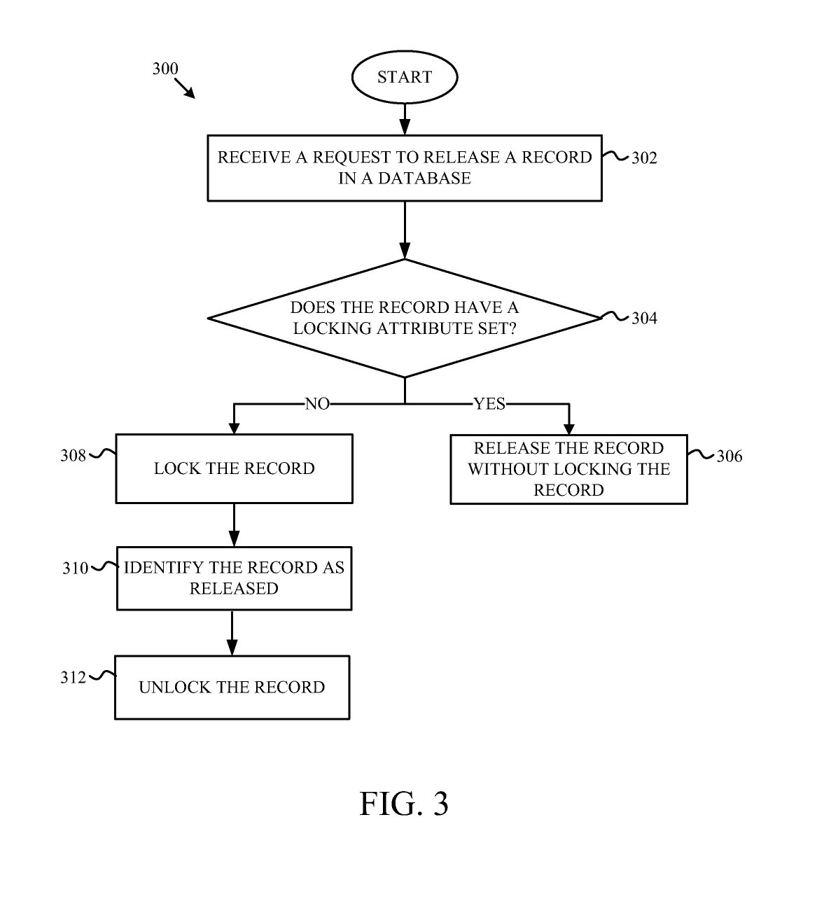

The exemplary method of FIG. 2 may be implemented in a database storing records having the attribute flag set or not set. FIG. 3 is a flow chart illustrating an exemplary method of releasing a record according to another embodiment of the disclosure. A method 300 begins at block 302 with receiving a request to release a record in a database. At block 304, the database examines if the record for release has a locking attribute set. According to one embodiment, the locking attribute may be a flag associated with a file containing the record. According to another embodiment, the locking attribute may be a flag stored in the database for each record individually.

If the locking attribute is set, then the method 300 continues to block 306 to release the record without locking the record. The example embodiment of FIG. 3 illustrates that the locking attribute is set to indicate the record is a non-locking record. However, the locking attribute value may be inverted such that the record is released without locking when the locking attribute is not set. The locking attribute may be set at creation of the record or altered after the creation of the record.

If the locking attribute is not set, then the method 300 continues to block 308 to lock the record. At block 310, the database waits for the record to be identified as released, and, at block 312, the record is unlocked after the record is identified as released.

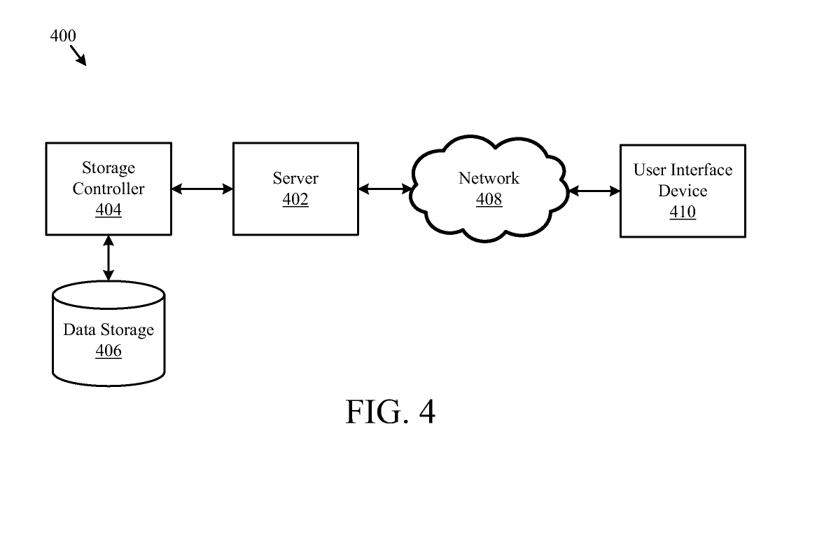

FIG. 4 illustrates one embodiment of a system 400 for an information system. The system 400 may include a server 402, a data storage device 406, a network 408, and a user interface device 410. The server 402 may be a dedicated server or one server in a cloud computing system. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone or other a mobile communication device having access to the network 408. When the device 410 is a mobile device, sensors (not shown), such as a camera or accelerometer, may be embedded in the device 410. When the device 410 is a desktop computer the sensors may be embedded in an attachment (not shown) to the device 410. In a further embodiment, the user interface device 410 may access the Internet or other wide area or local area network to access a web application or web service hosted by the server 402 and provide a user interface for enabling a user to enter or receive information.

The network 408 may facilitate communications of data, such as authentication information, between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 410 accesses the server 402 through an intermediate sever (not shown). For example, in a cloud application the user interface device 410 may access an application server. The application server fulfills requests from the user interface device 410 by accessing a database management system (DBMS). In this embodiment, the user interface device 410 may be a computer or phone executing a Java application making requests to a JBOSS server executing on a Linux server, which fulfills the requests by accessing a relational database management system (RDMS) on a mainframe server.

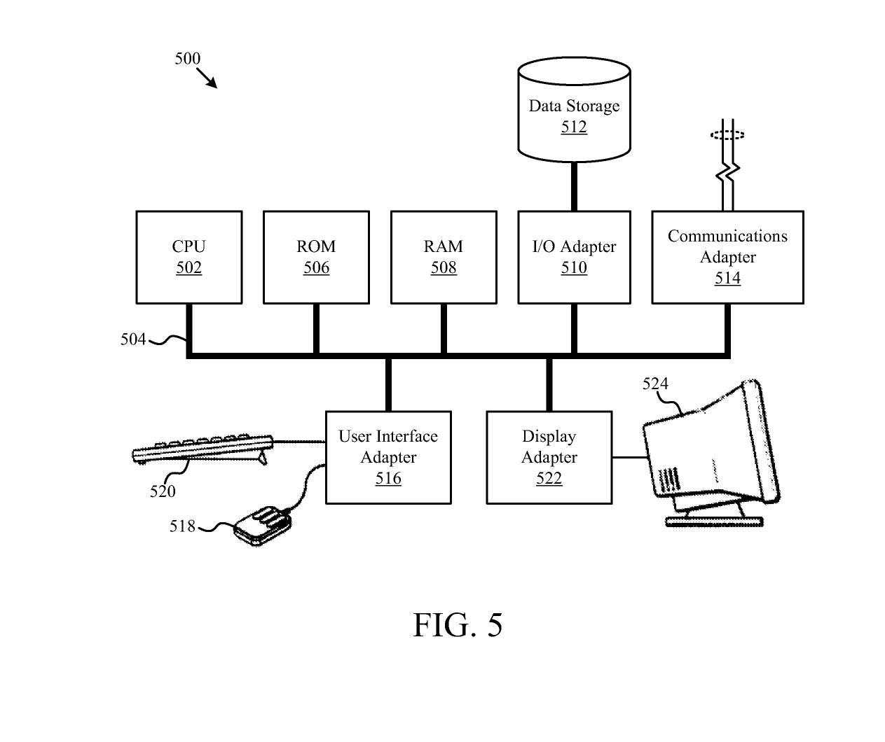

FIG. 5 illustrates a computer system 500 adapted according to certain embodiments of the server 402 and/or the user interface device 410. The central processing unit (“CPU”) 502 is coupled to a system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the modules and operations as described herein. The CPU 502 may execute the various logical instructions according to the present embodiments.

The computer system 500 also may include random access memory (RAM) 508, which may be synchronous RAM (SRAM), dynamic RAM (DRAM), and/or synchronous dynamic RAM (SDRAM). The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a flash drive, a compact disc (CD) drive, a floppy disk drive, and a tape drive, to the computer system 500. The communications adapter 514 may be adapted to couple the computer system 500 to the network 408, which may be one or more of a LAN, WAN, and/or the Internet. The communications adapter 514 may also be adapted to couple the computer system 500 to other networks such as a global positioning system (GPS) or a Bluetooth network. The user interface adapter 516 couples user input devices, such as a keyboard 520, a pointing device 518, and/or a touch screen (not shown) to the computer system 500. The keyboard 520 may be an on-screen keyboard displayed on a touch panel. Additional devices (not shown) such as a camera, microphone, video camera, accelerometer, compass, and or a gyroscope may be coupled to the user interface adapter 516. The display adapter 522 may be driven by the CPU 502 to control the display on the display device 524.

The applications of the present disclosure are not limited to the architecture of computer system 500. Rather the computer system 500 is provided as an example of one type of computing device that may be adapted to perform the functions of a server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a request to release a record in a database;
identifying the record as a non-locking record; and
releasing the record without locking the record.

2. The method of claim 1, in which the step of releasing the record comprises writing a free bit pattern to the record.

3. The method of claim 1, in which the step of identifying the record comprises identifying a set flag on the record.

4. The method of claim 1, in which the step of identifying the record comprises identifying a set flag on a file in which the record is stored.

5. The method of claim 1, in which the database is stored on multiple host computer systems.

6. The method of claim 1, further comprising when the record is not identified as a non-locking record:
locking the record;
releasing the record; and
unlocking the record.

7. A computer program product, comprising:
a non-transitory computer readable medium comprising:
code to receive a request to release a record in a database;
code to identify the record as a non-locking record; and
code to release the record without locking the record.

8. The computer program product of claim 7, in which the code to release the record comprises code to write a free bit pattern to the record.

9. The computer program product of claim 7, in which the code to identify the record comprises code to identify a set flag on the record.

10. The computer program product of claim 7, in which the code to identify the record comprises code to identify a set flag on a file in which the record is stored.

11. The computer program product of claim 7, in which the database is stored on multiple host computer systems.

12. The computer program product of claim 7, in which the medium further comprises:
code to, when the record is not identified as a non-locking record, lock the record;
code to release the record; and
code to unlock the record.

13. An apparatus, comprising:
a processor; and
a memory storing at least a portion of a database, in which the memory is coupled to the processor,
in which the processor is configured:
to receive a request to release a record in the database;
to identify the record as a non-locking record; and
to release the record without locking the record.

14. The apparatus of claim 13, in which the processor is configured to write a free bit pattern to the record.

15. The apparatus of claim 13, in which the processor is configured to identify a set flag on the record to determine if the record is a non-locking record.

16. The apparatus of claim 13, in which the processor is configured to identify a set flag on a file in which the record is stored to determine if the record is a non-locking record.

17. The apparatus of claim 13, further comprising a second processor and a second memory storing at least a portion of the database, in which the database is stored on multiple host computer systems.

18. The apparatus of claim 13, in which the processor is further configured:
to, when the record is not identified as a non-locking record, lock the record;
to release the record; and
to unlock the record.
